(19) United States
(12) Patent Application Publication
(10) Pub. No.: US 2024/0387910 A1
(43) Pub. Date: Nov. 21, 2024

(54) SOLID-STATE BATTERY PACKAGE

(71) Applicant: Murata Manufacturing Co., Ltd., Nagaokakyo-shi (JP)

(72) Inventors: Takayuki NAGANO, Nagaokakyo-shi (JP); Yoshihito NIWA, Nagaokakyo-shi (JP)

(21) Appl. No.: 18/788,479

(22) Filed: Jul. 30, 2024

Related U.S. Application Data
(63) Continuation of application No. PCT/JP2023/008665, filed on Mar. 7, 2023.

(30) Foreign Application Priority Data
Mar. 23, 2022 (JP) 2022-047311

(51) Int. Cl. H01M 50/124; H01M 50/11; H01M 50/117; H01M 50/119; H01M 50/121; H01M 50/122; H01M 50/126; H01M 50/133; H01M 50/136

(52) U.S. Cl. CPC H01M 50/124; H01M 50/11; H01M 50/117; H01M 50/119; H01M 50/121; H01M 50/122; H01M 50/126; H01M 50/133; H01M 50/136

(57) ABSTRACT

A solid-state battery package including: a substrate; a solid-state battery on the substrate; a covering portion covering the solid-state battery; and a shape-maintaining layer in contact with the covering portion.

### CROSS REFERENCE TO RELATED APPLICATIONS

The present application is a continuation of International application No. PCT/JP2023/008665, filed Mar. 7, 2023, which claims priority to Japanese Patent Application No. 2022-047311, filed Mar. 23, 2022, the entire contents of each of which are incorporated herein by reference.

### TECHNICAL FIELD

The present disclosure relates to a solid-state battery package. More specifically, the present disclosure relates to a solid-state battery packaged to be adapted for mounting.

### BACKGROUND ART

Conventionally, secondary batteries that can be repeatedly charged and discharged have been used for various applications. For example, secondary batteries are used as power sources of electronic devices such as smartphones and notebooks.

In a secondary battery, a liquid electrolyte is generally used as a medium for ion transfer that contributes to charge and discharge. That is, a so-called electrolytic solution is used for the secondary battery. However, in such a secondary battery, safety is generally required in terms of preventing leakage of the electrolytic solution. Since an organic solvent or the like used for the electrolytic solution is a flammable substance, safety is required also in that respect.

Therefore, a solid-state battery using a solid electrolyte instead of the electrolytic solution has been studied.
Patent Document 1: WO 2020/031424 A

### SUMMARY OF THE DISCLOSURE

It is conceivable that a solid-state battery is used by being mounted on a printed wiring board and the like together with other electronic components, and in that case, a structure suitable for mounting is required. For example, a solid-state battery package that is formed by disposing a solid-state battery on a substrate has the substrate electrically connect with the outside and thereby is adapted for mounting. In the solid-state battery package, the solid-state battery disposed on the substrate may be provided with a covering portion covering the solid-state battery.

The present inventors have found that the solid-state battery package can be deformed due to a difference in thermal expansion and contraction between members constituting the solid-state battery package (hereinafter, also referred to as “package component”) when exposed to a temperature change or the like.

The present disclosure has been made in view of such problems. That is, a main object of the present disclosure is to provide a solid-state battery package that copes with deformation caused by a difference in thermal expansion and contraction between package components.

The present disclosure provides a solid-state battery package including: a substrate; a solid-state battery on the substrate; a covering portion covering the solid-state battery; and a shape-maintaining layer in contact with the covering portion.

According to the present disclosure, it is possible to provide a solid-state battery package that copes with deformation caused by a difference in thermal expansion and contraction between package components. More specifically, in the solid-state battery package of the present disclosure, deformation caused by a difference in thermal expansion and contraction between the package components is reduced.

### BRIEF EXPLANATION OF THE DRAWINGS

FIG. 1 is a sectional view schematically illustrating an embodiment of the present disclosure.

FIG. 2 is a sectional view schematically illustrating an embodiment of the present disclosure.

FIG. 3 is a sectional view schematically illustrating an embodiment of the present disclosure.

FIG. 4 is a sectional view schematically illustrating an embodiment of the present disclosure.

FIGS. 5(A) to 5(D) are process sectional views schematically illustrating a process for obtaining a solid-state battery package according to an embodiment of the present disclosure.

FIGS. 6(A) to 6(E) are process sectional views schematically illustrating a process for obtaining a solid-state battery package according to an embodiment of the present disclosure.

FIG. 7 is a sectional view schematically illustrating a conventional solid-state battery package.

### DESCRIPTION OF THE PREFERRED EMBODIMENTS

Hereinafter, the solid-state battery of the present disclosure will be described in detail. Although the description will be made with reference to the drawings as necessary, the illustrated contents are only schematically and exemplarily illustrated for the understanding of the present disclosure, and the appearance, the dimensional ratio, or the like may be different from the actual ones.

The term “solid-state battery package” as used herein refers, in a broad sense, to a solid-state battery device (or a solid-state battery article) configured to protect the solid-state battery from the external environment, and in a narrow sense, to a solid-state battery article that includes a substrate adapted for mounting and protects the solid-state battery from the external environment.

The term “sectional view” as used herein is based on a form viewed from a direction substantially perpendicular to the stacking direction in the stacked structure of the solid-state battery (briefly, a form in the case of being cut along a plane parallel to the layer thickness direction). In addition, the term “plan view” or “plan view shape” as used herein is based on a sketch drawing when an object is viewed from an upper side or a lower side along the layer thickness direction (that is, the above stacking direction).

The terms “vertical direction” and “horizontal direction” directly or indirectly as used herein respectively correspond to the vertical direction and the horizontal direction in the drawings. Unless otherwise specified, the same reference signs or symbols denote the same members and sites, or the same semantic contents. In a preferred embodiment, it can be understood that a downward direction in a vertical direction (that is, a direction in which gravity acts) corresponds to a “downward direction”/a “bottom surface side”, and the opposite direction thereof corresponds to an “upward direction”/a “top surface side”.

The term “solid-state battery” used in the present disclosure refers to, in a broad sense, a battery whose constituent elements are composed of solid and refers to, in a narrow sense, an all-solid-state battery whose constituent elements (particularly preferably all constituent elements) are composed of solid. In a preferred embodiment, the solid-state battery in the present disclosure is a stacked solid-state battery configured such that layers constituting a battery constituent unit are stacked on each other, and such layers are preferably composed of fired bodies. The term “solid-state battery” encompasses not only a so-called “secondary battery” that can be repeatedly charged and discharged but also a “primary battery” that can only be discharged. According to a preferred embodiment of the present disclosure, the “solid-state battery” is a secondary battery. The term “secondary battery” is not excessively restricted by its name, which can encompass, for example, a power storage device and the like. In the present disclosure, the solid-state battery included in the package can also be referred to as a “solid-state battery element”.

Hereinafter, the basic configuration of the solid-state battery according to the present disclosure will be first described. The configuration of the solid-state battery described here is merely an example for understanding the disclosure, and not considered limiting the disclosure.

### [Basic Configuration of Solid-State Battery]

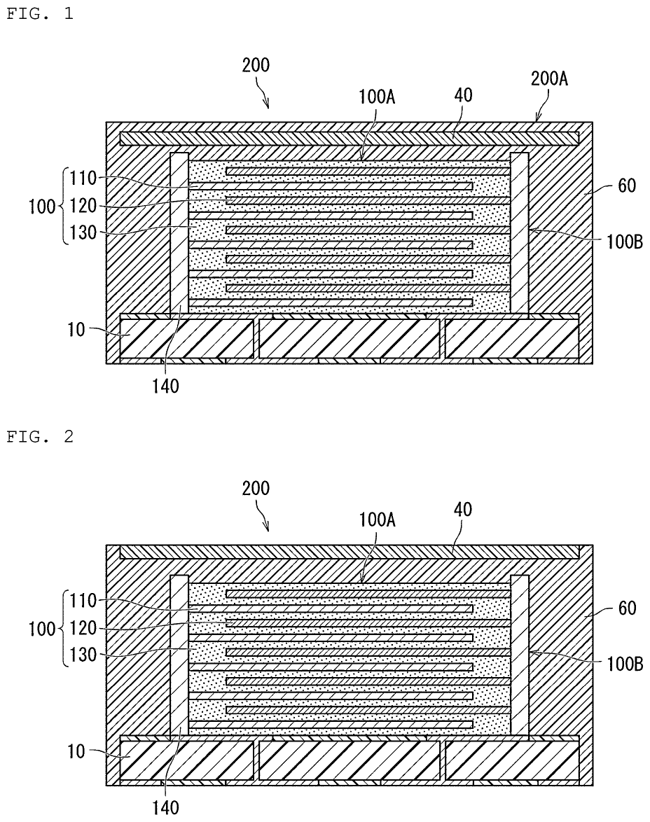

A solid-state battery includes at least positive and negative electrode layers and a solid electrolyte. Specifically, as illustrated in FIG. 1, a solid-state battery 100 includes a solid-state battery stacked body having a battery constituting unit consisting of a positive electrode layer 110, a negative electrode layer 120, and a solid electrolyte 130 at least interposed between these electrode layers.

For the solid-state battery, each layer constituting the solid-state battery may be formed by firing, and the positive electrode layer, the negative electrode layer, the solid electrolyte, and the like may form fired layers. Preferably, the positive electrode layer, the negative electrode layer, and the solid electrolyte are each fired integrally with each other, and thus, the solid-state battery stacked body preferably forms an integrally fired body.

The positive electrode layer 110 is an electrode layer containing at least a positive electrode active material. The positive electrode layer may further contain a solid electrolyte. In a preferred embodiment, the positive electrode layer is composed of a fired body including at least positive electrode active material particles and solid electrolyte particles. In contrast, the negative electrode layer is an electrode layer containing at least a negative electrode active material. The negative electrode layer may further contain a solid electrolyte. In a preferred embodiment, the negative electrode layer is composed of a sintered body containing at least negative electrode active material particles and solid electrolyte particles.

The positive electrode active material and the negative electrode active material are substances involved in the transfer of electrons in the solid-state battery. Ions move (or conduct) between the positive electrode layer and the negative electrode layer through the solid electrolyte to accept and donate electrons, whereby charging and discharging are performed. Each electrode layer: the positive electrode layer and the negative electrode layer is preferably a layer capable of occluding and releasing lithium ions or sodium ions, in particular. More particularly, the solid-state battery is preferably an all-solid-state secondary battery in which lithium ions or sodium ions move between the positive electrode layer and the negative electrode layer through the solid electrolyte interposed, thereby charging and discharging the battery.

### (Positive Electrode Active Material)

Examples of the positive electrode active material included in the positive electrode layer 110 include at least one selected from the group consisting of lithium-containing phosphate compounds that have a NASICON-type structure, lithium-containing phosphate compounds that have an olivine-type structure, lithium-containing layered oxides, lithium-containing oxides that have a spinel-type structure, and the like. Examples of the lithium-containing phosphate compounds that have a NASICON-type structure include Li₃V₂(PO₄)₃. Examples of the lithium-containing phosphate compounds that have an olivine-type structure include Li₃Fe₂(PO₄)₃, LiFePO₄, and/or LiMnPO₄. Examples of the lithium-containing layered oxides include LiCoO₂ and/or LiCo_{1/3}Ni_{1/3}Mn_{1/3}O₂. Examples of the lithium-containing oxides that have a spinel-type structure include LiMn₂O₄ and/or LiNi_{0.5}Mn_{1.5}O₄.

In addition, examples of positive electrode active materials capable of occluding and releasing sodium ions include at least one selected from the group consisting of sodium-containing phosphate compounds that have a NASICON-type structure, sodium-containing phosphate compounds that have an olivine-type structure, sodium-containing layered oxides, sodium-containing oxides that have a spinel-type structure, and the like.

### (Negative Electrode Active Material)

Examples of the negative electrode active material contained in the negative electrode layer 120 include at least one selected from the group consisting of an oxide containing at least one element selected from the group consisting of Ti, Si, Sn, Cr, Fe, Nb, and Mo, a carbon material such as graphite, a graphite-lithium compound, a lithium alloy, a lithium-containing phosphate compound having a NASICON-type structure, a lithium-containing phosphate compound having an olivine-type structure, and a lithium-containing oxide having a spinel-type structure. Examples of the lithium alloys include Li—Al. Examples of the lithium-containing phosphate compounds that have a NASICON-type structure include Li₃V₂(PO₄)₃ and/or LiTi₂(PO₄)₃. Examples of the lithium-containing phosphate compounds that have an olivine-type structure include Li₃Fe₂(PO₄)₃ and/or LiCuPO₄. Examples of the lithium-containing oxides that have a spinel-type structure include Li₄Ti₅O₁₂.

In addition, examples of negative electrode active materials capable of occluding and releasing sodium ions include at least one selected from the group consisting of sodium-containing phosphate compounds that have a NASICON-type structure, sodium-containing phosphate compounds that have an olivine-type structure, and sodium-containing oxides that have a spinel-type structure.

Further, in the solid-state battery, the positive electrode layer and the negative electrode layer may be made of the same material.

The positive electrode layer and/or the negative electrode layer may include a conductive material. Examples of the conductive material included in the positive electrode layer and the negative electrode layer include at least one of metal materials such as silver, palladium, gold, platinum, aluminum, copper, and nickel, and carbon.

Further, the positive electrode layer and/or the negative electrode layer may contain a sintering aid. Examples of the sintering aid include at least one selected from the group consisting of lithium oxide, sodium oxide, potassium oxide, boron oxide, silicon oxide, bismuth oxide, and phosphorus oxide.

The thicknesses of the positive electrode layer and negative electrode layer are not particularly limited, but may be, independently of each other, for example, 2 μm to 50 μm, particularly 5 μm to 30 μm.

### (Positive Electrode Current Collecting Layer/Negative Electrode Current Collecting Layer)

Although not an essential element for the electrode layer, the positive electrode layer 110 and the negative electrode layer 120 may respectively include a positive electrode current collecting layer and a negative electrode current collecting layer. The positive electrode current collecting layer and the negative electrode current collecting layer may each have the form of a foil. The positive electrode current collecting layer and the negative electrode current collecting layer may each have, however, the form of a fired body, if more importance is placed on viewpoints such as improving the electron conductivity, reducing the manufacturing cost of the solid-state battery, and/or reducing the internal resistance of the solid-state battery by integral firing. As the positive electrode current collector constituting the positive electrode current collecting layer and the negative electrode current collector constituting the negative electrode current collecting layer, it is preferable to use a material with a high conductivity, and for example, silver, palladium, gold, platinum, aluminum, copper, and/or nickel may be used. The positive electrode current collector and the negative electrode current collector may each have an electrical connection part for being electrically connected to the outside, and may be configured to be electrically connectable to an end-face electrode. When the positive electrode current collecting layer and the negative electrode current collecting layer have the form of a fired body, the layers may be composed of a fired body including a conductive material and a sintering aid. The conductive material included in the positive electrode current collecting layer and the negative electrode current collecting layer may be selected from, for example, the same materials as the conductive materials that can be included in the positive electrode layer and the negative electrode layer. The sintering aid included in the positive electrode current collecting layer and the negative electrode current collecting layer may be selected from, for example, the same materials as the sintering aids that can be included in the positive electrode layer/the negative electrode layer. As described above, in the solid-state battery, the positive electrode current collecting layer and the negative electrode current collecting layer are not essential, and a solid-state battery provided without such a positive electrode current collecting layer or a negative electrode current collecting layer is also conceivable. More particularly, the solid-state battery included in the package of the present disclosure may be a solid-state battery without any current collecting layer.

### (Solid Electrolyte)

The solid electrolyte is a material capable of conducting lithium ions or sodium ions. In particular, the solid electrolyte 130 that forms the battery constituent unit in the solid-state battery may form a layer capable of conducting lithium ions between the positive electrode layer 110 and the negative electrode layer 120. A specific solid electrolyte may be, for example, an oxide-based solid electrolyte, and examples thereof include a lithium-containing phosphate compound having a NASICON-type structure, an oxide having a perovskite structure, an oxide having a garnet-type or garnet-type similar structure, and an oxide glass ceramic-based lithium ion conductor. Examples of the lithium-containing phosphate compound having a NASICON structure include LiₓM_{y}(PO₄)₃ (1≤x≤2, 1≤y≤2, M is at least one selected from the group consisting of Ti, Ge, Al, Ga and Zr). As an example of the lithium-containing phosphate compound having a NASICON structure, Li_{1.2}Al_{0.2}Ti_{1.8}(PO₄)₃ and the like can be mentioned, for example. Examples of the oxides that have a perovskite structure include La_{0.55}Li_{0.35}TiO₃. Examples of the oxides that have a garnet-type or garnet-type similar structure include Li₇La₃Zr₂O₁₂. As the oxide glass ceramic-based lithium ion conductor, for example, a phosphate compound (LATP) containing lithium, aluminum, and titanium as constituent elements, and a phosphate compound (LAGP) containing lithium, aluminum, and germanium as constituent elements can be used.

Examples of the solid electrolyte capable of conducting sodium ions include a sodium-containing phosphate compound having a NASICON structure, an oxide having a perovskite structure, and an oxide having a garnet-type structure or a garnet-type similar structure. Examples of the sodium-containing phosphate compound having a NASICON structure include NaₓM_{y}(PO₄)₃(1≤x≤2, 1≤y≤2, and M is at least one selected from the group consisting of Ti, Ge, Al, Ga, and Zr).

The solid electrolyte may include a sintering aid. The sintering aid included in the solid electrolyte may be selected from, for example, the same materials as the sintering aids that can be included in the positive electrode layer/the negative electrode layer.

The thickness of the solid electrolyte is not particularly limited. The thickness of the solid electrolyte layer located between the positive electrode layer and the negative electrode layer may be, for example, 1 μm to 15 μm, particularly 1 μm to 5 μm.

### (End-Face Electrode)

The solid-state battery is generally provided with an end-face electrode. In particular, an end-face electrode is provided on a side surface of the solid-state battery. More specifically, an end-face electrode on the positive electrode side connected to the positive electrode layer 110 and an end-face electrode on the negative electrode side connected to the negative electrode layer 120 are provided. Such end-face electrodes preferably contain a material having high conductivity. The specific material for the end-face electrode is not particularly limited, but examples thereof include at least one selected from the group consisting of silver, gold, platinum, aluminum, copper, tin, and nickel.

### [Feature of Solid-State Battery Package According to Present Disclosure]

FIG. 1 illustrates a solid-state battery package according to an embodiment of the present disclosure. Specifically, as shown in FIG. 1, a solid-state battery package 200 of the present disclosure includes: a substrate 10; a solid-state battery 100 provided on the substrate 10; and a covering portion 60 provided to cover the solid-state battery 100, wherein the covering portion 60 is provided with a shape-maintaining layer 40. Such a battery package 200 is provided with the substrate 10 and the covering portion 60 therearound such that the solid-state battery 100 is surrounded as a whole (none of the surfaces of the solid-state battery 100 is exposed to the outside).

The term “shape-maintaining layer” in the present disclosure is a layer that contributes to maintaining the shape of the solid-state battery package, in other words, a layer that suppresses or reduces deformation of the shape of the solid-state battery package. For example, the shape-maintaining layer suppresses or reduces warpage, distortion, and the like of the solid-state battery package as a whole due to heat.

The solid-state battery package 200 of the present disclosure can achieve the effects described below by adopting the above embodiment.

FIG. 7 shows a conventional solid-state battery package 200′. Each of the members (substrate 10′, covering portion 60′, solid-state battery 100′, or the like) constituting the solid-state battery package 200′ has an inherent thermal expansion coefficient. Therefore, each of the members constituting the solid-state battery package 200′ may inherently thermally expand and contract when exposed to a temperature change. Such a temperature change can be assumed when the solid-state battery package is produced, when the solid-state battery package is surface-mounted, when the solid-state battery package is used, or the like, as described above.

When the temperature is changed, among the members constituting the conventional solid-state battery package 200′, the thermal expansion and contraction of the substrate 10′ is relatively small, but the thermal expansion and contraction of the covering portion 60′ is relatively large, for example. Therefore, a relatively large difference in thermal expansion and contraction occurs between the thermal expansion and contraction of the substrate 10′ and the thermal expansion and contraction of the covering portion 60′. The conventional solid-state battery package 200′ may be deformed due to such a difference in thermal expansion and contraction. For example, the solid-state battery package 200′ as a whole may be deformed to warp.

As shown in FIG. 1, the solid-state battery package 200 of the present disclosure is provided with the shape-maintaining layer 40 in the covering portion 60 that covers the solid-state battery 100. The shape-maintaining layer 40 has a desired thermal expansion coefficient. Therefore, the shape-maintaining layer 40 present therein suppresses or reduces warpage, distortion, and the like of the solid-state battery package 200 as a whole due to heat. That is, the shape-maintaining layer 40 included in the solid-state battery package 200 of the present disclosure suppresses or reduces deformation of the solid-state battery package 200 due to a difference in thermal expansion and contraction.

The above-described deformation includes deformation when the solid-state battery package 200 is produced, deformation when the solid-state battery package 200 is surface-mounted, deformation when the solid-state battery package 200 is used, or the like. Examples of the deformation when the solid-state battery package 200 is produced include deformation caused by a difference in thermal expansion and contraction between package components due to heat treatment for curing the resin. Examples of the deformation when the solid-state battery package 200 is surface-mounted include deformation caused by thermal expansion and contraction between the package components due to thermal change during reflow treatment. Examples of the deformation when the solid-state battery package 200 is used include deformation caused by a difference in thermal expansion and contraction between package components due to heat generation during charging the solid-state battery 100, or use in a high-temperature environment or a low-temperature environment. The shape-maintaining layer 40 according to an embodiment of the present disclosure may act as a layer that suppresses or reduces at least one of such deformations.

In a broad sense, the deformation of the solid-state battery package means that the solid-state battery package has a shape deviating from a desired package shape. In a narrow sense, for example, the deformation of the solid-state battery package means that the solid-state battery package has a portion whose contour is at least curved as a whole in a sectional view. For example, the solid-state battery package may be warped, inclined, or distorted as a whole. The phrase the solid-state battery package is warped as a whole means that the whole solid-state battery package 200 is curved. For example, it can be also assumed for the deformation of the solid-state battery package that the main surface of the solid-state battery package 200 is deformed so as to recess in a concave shape as a whole or the main surface of the solid-state battery package 200 is deformed so as to expand in a convex shape as a whole. The shape-maintaining layer 40 according to an embodiment of the present disclosure can suppress or reduce the deformation as long as the deformation is caused at least by a difference in thermal expansion and contraction between the package components. The solid-state battery package 200 may be deformed over the whole surface of the solid-state battery package 200, or may be deformed only in a partial region of the surface of the solid-state battery package 200.

The thermal expansion and contraction means that the object expands or the member contracts due to temperature change of the object. For example, each member of the solid-state battery package 200 may expand as the temperature increases, and may contract as the temperature decreases.

As described above, the shape-maintaining layer 40 contributes to maintaining the shape of the solid-state battery package 200. As compared with the conventional solid-state battery package 200′, the solid-state battery package 200 including the shape-maintaining layer 40 can preferably suppress deformation against a force acting from the outside and/or the inside in addition to deformation caused by thermal expansion and contraction. For example, it is possible to suppress surface cracking of the solid-state battery package 200′ due to expansion of the solid-state battery caused by charging and discharging the solid-state battery 100. Further, for example, when the solid-state battery package 200′ is pressed, the solid-state battery package 200′ can be prevented from being deformed.

The solid-state battery package 200 of the present disclosure is packaged with the substrate 10 and the covering portion 60, and is a battery having more excellent water vapor transmission preventing property. Specifically, the substrate 10 is disposed proximally on one main surface side of the solid-state battery 100, and provided so as to shield the main surface of solid-state battery 100 from the external environment. The top surface 100A and side surface 100B of the solid-state battery 100 on the substrate 10 are covered with the covering portion 60, thereby shielding the solid-state battery 100 from the external environment. As a result, it is possible to suppress deterioration of the battery characteristics due to water vapor (more specifically, a phenomenon where water vapor from the external environment is mixed to deteriorate the characteristics of the solid-state battery). The term “water vapor” as used herein is not particularly limited to water in a gaseous state, and also encompasses water in a liquid state and the like. That is, the term “water vapor” is used to broadly include matters related to water regardless of the physical state. Therefore, the “water vapor” can also be referred to as moisture or the like, and in particular, as the water in the liquid state, dew condensation water in which water in a gaseous state is condensed can also be included.

Hereinafter, a possible embodiment of the solid-state battery package of the present disclosure will be described in detail.

Among the members constituting the solid-state battery package, typically, the covering portion is relatively easily deformed compared to the substrate. Specifically, when the temperature of the solid-state battery package changes, the covering portion may thermally expand and contract relatively largely, while the substrate may thermally expand and contract relatively small. The solid-state battery package may be deformed due to a difference between thermal expansion and contraction of the covering portion and thermal expansion and contraction of the substrate. In particular, since the covering portion provided above the solid-state battery package (for example, above the solid-state battery) is opposite to the substrate in positional relationship, warpage is likely to occur due to a temperature change like a bimetal. In other words, among the covering portions covering the solid-state battery package, the covering portion provided above the solid-state battery package is more likely to be greatly deformed than the covering portion constituting the other surfaces of the solid-state battery package when thermally expanded and contracted due to a temperature change.

In the present disclosure, since the shape-maintaining layer 40 contributing to prevention of deformation caused by a difference between thermal expansion and contraction of the covering portion 60 and thermal expansion and contraction of the substrate 10 is provided, deformation of the solid-state battery package 200 can be suitably suppressed or reduced. As illustrated in FIG. 1, when the solid-state battery package 200 is viewed such that the solid-state battery 100 is positioned above the substrate 10, the shape-maintaining layer 40 may be positioned above the solid-state battery 100. In other words, the shape-maintaining layer may be positioned above the main surface of the solid-state battery on the side opposite to the substrate (for example, the top surface 100A of the solid-state battery). In the embodiment shown in FIG. 1, since the shape-maintaining layer 40 is positioned above the solid-state battery 100, the solid-state battery 100 is positioned between the substrate 10 and the shape-maintaining layer 40.

The position where the shape-maintaining layer 40 is positioned is not particularly limited as long as it is above the solid-state battery 100. For example, the shape-maintaining layer 40 may be provided on the top surface side (also referred to as upper surface side) 200A of the solid-state battery package 200. Alternatively, the shape-maintaining layer 40 may be buried in the covering portion 60. When the shape-maintaining layer 40 is buried in the covering portion 60, the shape-maintaining layer 40 is not usually exposed from the surface of the solid-state battery package 200, and the shape-maintaining layer 40 may be covered with the covering portion 60 as a whole.

Specifically, a part of the shape-maintaining layer 40 may be buried and positioned in the top surface 200A of the solid-state battery package 200. Alternatively, the shape-maintaining layer 40 may be positioned such that the shape-maintaining layer 40 is buried in the covering portion 60 as a whole. When the shape-maintaining layer 40 is buried and positioned in the covering portion 60 as a whole, for example, as shown in FIG. 2, the shape-maintaining layer 40 may be positioned relatively proximal to the top surface 200A of the solid-state battery package 200, or the shape-maintaining layer 40 may be positioned relatively proximal to the solid-state battery 100. In any form described above, deformation of the solid-state battery package 200 can be further suppressed or reduced.

The term “above” means a space or a place in the “upward direction” defined above compared to a certain object. For example, the phrase “the shape-maintaining layer is positioned above the solid-state battery” means that the shape-maintaining layer is positioned above the solid-state battery, that is, positioned in a space or a place opposite to the direction in which gravity acts.

When FIG. 1 is viewed from another aspect, the covering portion 60 may be further provided on the shape-maintaining layer 40. In other words, the shape-maintaining layer 40 may be provided in the upper layer of the covering portion 60, or the periphery of the shape-maintaining layer 40 may be surrounded by the covering portion 60. In the embodiment illustrated in FIG. 1, the length from one end to the other end of the shape-maintaining layer 40 may be substantially as long as the length from one side surface to the other side surface of the covering portion. In other words, the end surface of the end portion of the shape-maintaining layer 40 and the side surface of the covering portion may be flush with each other.

The “upper layer of the covering portion 60” means the covering portion 60 on the side proximal to the top surface 200A of the solid-state battery package. For example, the upper layer of the covering portion 60 may be a covering portion in the covering portion 60 provided between the top surface 200A of the solid-state battery package and the top surface 100A of the solid-state battery.

When FIG. 2 is viewed from another aspect, the shape-maintaining layer 40 may be provided on the covering portion 60. For example, the shape-maintaining layer 40 may be provided such that the main surface of the shape-maintaining layer 40 and the main surface of the covering portion of the covering portion 60 overlap with each other. In other words, the shape-maintaining layer 40 may be provided such that the main surface of the shape-maintaining layer 40 and the main surface of the covering portion of the covering portion 60 are positioned substantially coplanar. The embodiment in which the main surface of the shape-maintaining layer 40 and the main surface of the covering portion 60 overlap with each other may be achieved, for example, in a form in which the shape-maintaining layer 40 is buried in the covering portion 60 as shown in FIG. 2, or may be achieved in a form in which the shape-maintaining layer 40 is outside the covering portion 60 (for example, in a form in which the shape-maintaining layer 40 is placed on the covering portion 60).

As can be seen from the above description, the term “top surface” as used herein means the surface that is positioned relatively at the upper side among the surfaces that constitute the solid-state battery package 200. Assuming a typical solid-state battery package with two opposing main surfaces, the term “top surface” as used herein refers to one of the main surfaces, and particularly means the main surface different from the main surface proximal to the substrate 10 (namely, the mounting surface side in the SMD type battery described later).

As deformation caused by a difference in thermal expansion and contraction between the package components, warpage deformation is relatively likely to occur. In this regard, the shape-maintaining layer 40 according to an embodiment of the present disclosure can particularly suppress or reduce warpage of the solid-state battery package 200 as a whole. That is, in such a case, the shape-maintaining layer 40 preferably corresponds to a warpage-prevention layer to prevent warpage of the solid-state battery package 200.

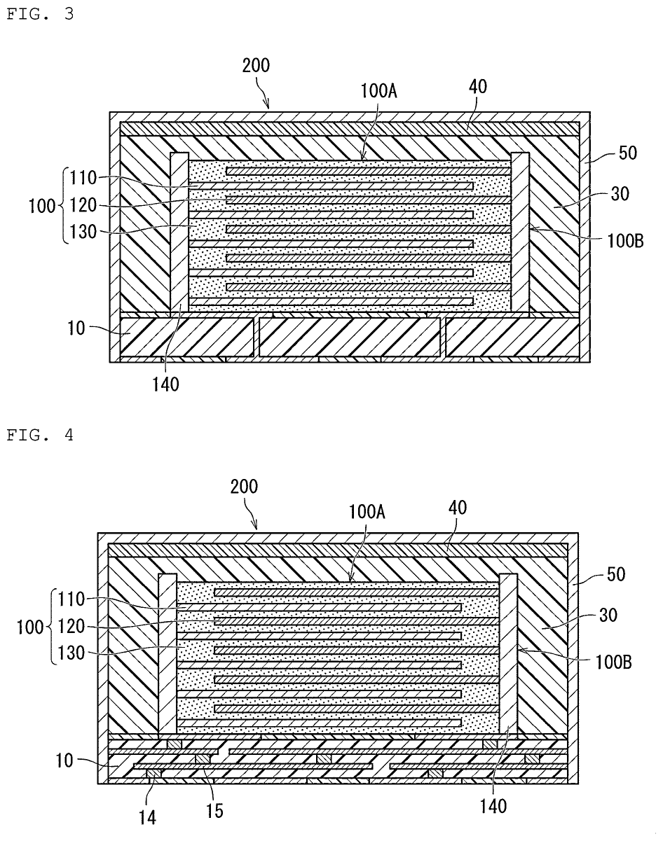

From the viewpoint of further reducing deformation of the solid-state battery package 200, the shape-maintaining layer 40 and the substrate 10 may be disposed in a parallel relationship with each other in a sectional view as illustrated in FIG. 3. The phrase “the shape-maintaining layer 40 and the substrate 10 may be disposed in a parallel relationship with each other” can mean that, for example, the separation distance between the shape-maintaining layer 40 and the substrate 10 is substantially constant in the plane direction. When the shape-maintaining layer 40 and the substrate 10 is disposed in a parallel relationship with each other, the direction in which the shape-maintaining layer 40 thermally expands and contracts and the direction in which the substrate 10 thermally expands and contracts are likely to be in a parallel relationship with each other. Therefore, the shape-maintaining layer 40 and the substrate 10 are likely to thermally expand and contract similarly, and deformation of the solid-state battery package 200 is more easily suppressed or reduced.

In an embodiment, in the sectional view as shown in FIG. 3, the solid-state battery package 200 may adopt an arrangement form of the shape-maintaining layer in which the extending direction of the side surface 100B of the solid-state battery is substantially orthogonal to the shape-maintaining layer 40. In particular, when the solid-state battery 100 can be arranged on the substrate 10 such that the extending direction of the side surface 100B of the solid-state battery is substantially orthogonal to the substrate 10 and the shape-maintaining layer 40 is also arranged as above, the direction in which the substrate 10 thermally expands and contracts and the direction in which the shape-maintaining layer 40 thermally expands and contracts are easily aligned. Therefore, deformation of the solid-state battery package 200 can be more easily suppressed or reduced.

In an embodiment, in the sectional view as shown in FIG. 3, the distance from one end to the other end of the shape-maintaining layer 40 may be longer than the distance between one side surface 100B and the other side surface 100B of the solid-state battery. The distance from one end to the other end of the substrate 10 is usually longer than the distance between the side surfaces 100B of the solid-state battery. When the shape-maintaining layer 40 having the length as described above is used, the distance from one end to the other end of each of the substrate 10 and the shape-maintaining layer 40 can be easily approximated. Therefore, the difference between the magnitude of thermal expansion and contraction of the substrate 10 and the magnitude of thermal expansion and contraction of the shape-maintaining layer 40 easily decreases, and deformation of the solid-state battery package 200 is more easily suppressed or reduced.

In an embodiment, in plan view, the outer contours of the shape-maintaining layer 40 and the substrate 10 may overlap with each other, and the sides forming the shapes of the shape-maintaining layer 40 and the substrate 10 may overlap with each other. In terms of dimension, in plan view, the shape-maintaining layer 40 may be substantially as long as the substrate 10 in one direction. The shape-maintaining layer 40 may be substantially as long as the substrate 10 in the other direction (for example, the direction orthogonal to the one direction). As illustrated in FIG. 1, in the sectional view, the shape-maintaining layer 40 may be substantially as wide as the substrate 10. By adopting such a configuration, the shape-maintaining layer 40 and the substrate 10 can have the same dimension, so that the deformation amount tends to be substantially equal when the shape-maintaining layer 40 and the substrate 10 thermally expand and contract. Therefore, the difference in thermal expansion and contraction between the shape-maintaining layer 40 and the substrate 10 may be further reduced. Therefore, warpage deformation due to a difference in thermal expansion and contraction between the members can be more easily suppressed or reduced.

Hereinafter, the members constituting the solid-state battery package of the present disclosure will be described in detail.

### [Shape-Maintaining Layer]

The shape-maintaining layer may contain a resin. For example, the shape-maintaining layer may contain a resin component, or the shape-maintaining layer may be a resin layer. Specifically, the shape-maintaining layer may contain a thermosetting resin or a thermoplastic resin. That is, the shape-maintaining layer may be a thermosetting resin layer or a thermoplastic resin layer.

As the thermosetting resin, for example, at least one selected from the group consisting of an epoxy resin, a modified epoxy resin, a silicone resin, a phenol resin, a urea resin, a melamine resin, an unsaturated polyester resin, a polyimide resin, a diallyl phthalate resin, a polyaminobismaleimide resin, a polyurethane resin, and an alkyd resin can be used. From the viewpoint of further reducing deformation of the solid-state battery package, the shape-maintaining layer may contain an epoxy resin. When the shape-maintaining layer contains an epoxy resin, thermal expansion and contraction of the shape-maintaining layer can be easily adjusted. Specifically, it becomes easy to adjust to reduce the difference in thermal expansion and contraction between the shape-maintaining layer and the substrate, and the effect of preventing deformation of the present disclosure becomes more apparent.

As the thermoplastic resin, for example, at least one selected from the group consisting of a polyamide resin, a polycarbonate resin, a polyphenylene sulfide resin, an aromatic polyether ketone resin, and a thermoplastic polyimide resin can be used.

The shape-maintaining layer may contain a filler in addition to the resin. As the filler, for example, an inorganic filler and/or an organic filler may be used. The inorganic filler may contain at least one selected from the group consisting of metal powders, carbon materials, silicon oxides, metal oxides, metal hydroxides, metal nitrides, and metal sulfates. For example, as the inorganic filler, ceramic particles, alumina particles, carbon black, graphite, silica particles, or the like may be used. The organic filler may contain an ABS resin, a polyamide resin, an etherimide resin, a polyphenylene sulfide resin, cellulose, a phenol resin, and/or the like. The shape of the inorganic filler and/or the organic filler is not particularly limited, and may be granular, spherical, needle-like, plate-like, fibrous, and/or amorphous.

As the inorganic filler and/or the organic filler used for the shape-maintaining layer, reinforcing fibers may be used. As the reinforcing fibers, for example, glass fibers, carbon fibers, aramid fibers, ceramic fibers, potassium titanate fibers, aluminum borate fibers, boron fibers, or the like may be used. The form of the reinforcing fiber may be a short fiber (or wool) member or a long fiber (or fiber) member. From the viewpoint of further reducing deformation of the solid-state battery package, a glass fiber may be used as the filler used for the shape-maintaining layer. Glass wool or glass fiber may be used as the form of the glass fiber. The glass fiber is a fiber having relatively small thermal expansion and contraction. When the shape-maintaining layer contains glass fiber, thermal expansion and contraction of the shape-maintaining layer is further reduced. When the shape-maintaining layer contains glass fiber, the shape-maintaining layer more easily suppresses or reduces warpage of the solid-state battery package as a whole.

In the preparation of the shape-maintaining layer, the shape-maintaining layer may contain a cloth member. The cloth member may be a cloth-like member made of fibers. The cloth member may be in any form such as a woven fabric, a knitted fabric, or a nonwoven fabric. The fibers constituting the cloth member may be glass fibers, carbon fibers, aramid fibers, ceramic fibers, potassium titanate fibers, aluminum borate fibers, boron fibers, or the like. From the viewpoint of further reducing deformation of the solid-state battery package, glass fibers may be used as fibers constituting the cloth member. That is, glass cloth may be used as the cloth member. As described above, the glass fiber has relatively small thermal expansion and contraction. Furthermore, since the glass cloth is a cloth member made of glass fiber, the strength can be improved as compared with a case where the glass fiber itself is used as it is. Therefore, when the shape-maintaining layer contains glass cloth, the shape-maintaining layer can more suitably suppress or reduce deformation of the solid-state battery package.

As the shape-maintaining layer, a layer in which reinforcing fibers are impregnated with a resin to form a sheet-like FRP (fiber-reinforced plastic) is contained may be used. The FRP may be formed by directly impregnating fibers with a resin, or may be formed using a prepreg. As the FRP, one obtained by impregnating a reinforcing fiber cloth member with a resin may be used, or one obtained by impregnating a sheet-like member in which reinforcing fibers are aligned in one direction (UD) with a resin may be used. The direction of the fibers, the way of knitting the fiber cloth, and the like are not particularly limited. From the viewpoint of further reducing deformation of the solid-state battery package, the shape-maintaining layer may be formed using a cloth prepreg. Regarding the characteristics contributing to the shape maintenance of the shape-maintaining layer, the isotropy is further improved, and the warpage of the solid-state battery package as a whole is easily suppressed or reduced. In a preferred embodiment, glass epoxy (also referred to as epoxy glass) obtained by impregnating glass cloth with an epoxy resin may be used. More specifically, the shape-maintaining layer may be a glass epoxy substrate. The shape-maintaining layer including glass epoxy can more suitably suppress or reduce deformation of the solid-state battery package.

The shape-maintaining layer may be a layer in which the resin is filled (preferably highly filled) with a filler. From the viewpoint of further reducing deformation of the solid-state battery package, for example, the content of the filler in the shape-maintaining layer may be preferably 30 wt % to 90 wt %, more preferably 50 wt % to 90 wt %, and still more preferably 70 wt % to 90 wt % with respect to the total weight of the shape-maintaining layer. When the shape-maintaining layer contains the filler within the above range, the warpage of the solid-state battery package as a whole is more easily suppressed or reduced.

The shape-maintaining layer may contain a metal. In other words, the shape-maintaining layer may contain a metal component. For example, the metal may occupy the total of the shape-maintaining layer, in which case the shape-maintaining layer may be a metal layer. As the metal layer, a metal foil may be used. The metal foil may contain, for example, copper, silver, titanium, aluminum, or stainless steel. The stainless steel refers to, for example, the stainless steel defined in “JIS G0203 Glossary of terms used in iron and steel”, and may be an alloy steel containing chromium or chromium and nickel. For example, the shape-maintaining layer may partly contain a metal, and in this case, the metal may be contained in the shape-maintaining layer as a filler. The filler contained in the shape-maintaining layer as a metal may be a metal particle or a metal oxide particle.

The method for providing the shape-maintaining layer in the covering portion is not particularly limited. For example, a raw material of the shape-maintaining layer (for example, when a resin and a filler are used, a member obtained by kneading the resin and the filler in advance and compounding them into a sheet-like material) may be provided in the covering portion, and then subjected to thermal curing or the like to form the shape-maintaining layer. Alternatively, a shape-maintaining layer formed in advance may be provided in the covering portion.

The thermal expansion coefficient has two types of thermal expansion coefficients including “linear expansion coefficient” and “volume expansion coefficient”, and the thermal expansion coefficient in the present disclosure means “linear expansion coefficient”. The thermal expansion coefficient in the present disclosure may be measured using, for example, a thermomechanical analyzer (TMA). The thermal expansion coefficient may be a value obtained by a method in accordance with JIS 7197:2012 “Testing method for linear thermal expansion coefficient of plastics by thermomechanical analysis”, JIS Z2285:2003 “Measuring method of coefficient of linear thermal expansion of metallic materials”, and JIS C 6481 “Test methods of copper-clad laminates for printed wiring boards”.

The “thermal expansion coefficient” as used herein may be an average linear thermal expansion coefficient measured in a temperature range of 0° C. to 300° C.

The thermal expansion coefficient of the shape-maintaining layer may be preferably 1 ppm/° C. to 25 ppm/° C., more preferably 5 ppm/° C. to 25 ppm/° C., still more preferably 5 ppm/° C. to 15 ppm/° C., and particularly preferably 7 ppm/° C. to 13 ppm/° C. When the thermal expansion coefficient of the shape-maintaining layer is within the above range, the difference in thermal expansion and contraction from other members (in particular, the substrate) of the solid-state battery package is easily adjusted to be small. Therefore, warpage of the solid-state battery package as a whole is more easily suppressed or reduced.

The thermal expansion coefficient of the shape-maintaining layer may be the thermal expansion coefficient of the material used as the shape-maintaining layer. For example, the thermal expansion coefficient of the shape-maintaining layer may be a thermal expansion coefficient value obtained by measuring the shape-maintaining layer before being provided in the solid-state battery package (for example, the state of a single material such as a substrate or a metal foil used for forming the shape-maintaining layer) in accordance with the measurement method exemplified above. Alternatively, the thermal expansion coefficient may be a thermal expansion coefficient value obtained by measuring the shape-maintaining layer taken out of the solid-state battery package in accordance with the measurement method exemplified above.

The thermal expansion coefficient of the shape-maintaining layer may be preferably 0.1 times to 2.5 times, more preferably 0.5 times to 2.5 times, still more preferably 0.5 times to 1.5 times, and particularly preferably 0.7 times to 1.3 times the thermal expansion coefficient of the substrate. As an example of the thermal expansion coefficient of the shape-maintaining layer and the thermal expansion coefficient of the substrate, for example, the thermal expansion coefficient of the substrate is 10 ppm/° C., and the thermal expansion coefficient of the shape-maintaining layer may be preferably 0.1 ppm/° C. to 25 ppm/° C., more preferably 0.5 ppm/° C. to 25 ppm/° C., still more preferably 5 ppm/° C. to 15 ppm/° C., and particularly preferably 7 ppm/° C. to 13 ppm/° C. When the thermal expansion coefficient of the shape-maintaining layer is within the above range, warpage of the solid-state battery package as a whole is more easily suppressed or reduced.

The thermal expansion coefficient of the shape-maintaining layer may be smaller than the thermal expansion coefficient of the covering portion. Specifically, the thermal expansion coefficient of the shape-maintaining layer may be smaller than the thermal expansion coefficient of the covering portion in a range of 10 ppm/° C. to 50 ppm/° C., preferably in a range of 20 ppm/° C. to 50 ppm/° C., and more preferably in a range of 30 ppm/° C. to 50 ppm/° C. When the thermal expansion coefficient of the shape-maintaining layer is within the above range, warpage of the solid-state battery package as a whole is more easily suppressed or reduced.

The shape-maintaining layer 40 itself may be a layer that is less likely to deform compared to other package components (in particular, the covering portion 60). By providing such a shape-maintaining layer 40 in the covering portion 60, thermal expansion and contraction of the covering portion 60 is easily suppressed by the shape-maintaining layer 40 present therein. In other words, the covering portion 60 provided with the shape-maintaining layer 40 tends to have relatively small thermal expansion and contraction as a whole. Therefore, the difference in thermal expansion and contraction between the covering portion 60 provided with the shape-maintaining layer 40 and the substrate 10 tends to be relatively small. That is, if there is a temperature change, deformation of the solid-state battery package 200 due to a difference between thermal expansion and contraction of the substrate 10 and thermal expansion and contraction of the covering portion 60 can be suppressed.

The Young's modulus of the shape-maintaining layer may be preferably 1.0 GPa to 450 GPa, more preferably 5.0 GPa to 450 GPa, still more preferably 10 GPa to 450 GPa, and particularly preferably 20 GPa to 450 GPa. As a method for measuring the Young's modulus, a dynamic viscoelasticity measurement, a tensile test, a compression test, a torsion test, a resonance method, an ultrasonic pulse method, a pendulum method, or the like may be used. For example, as the Young's modulus value, a value obtained by a method in accordance with JIS standard (JIS C 6481 “Test methods of copper-clad laminates for printed wiring boards”, JIS K 7244 “Plastics-Determination of dynamic mechanical properties”, JIS K 7161 “Plastics-Determination of tensile properties”, JIS K7171:2016 “Plastics-Determination of flexural properties”, JIS K 7181 “Plastics-Determination of compressive properties”, JIS Z2241:2011 “Metal material tensile test method”, and the like) is used. When the Young's modulus of the shape-maintaining layer is within the above range, the strength of the solid-state battery package can be improved. Therefore, if a force acts from the outside and/or the inside of the solid-state battery package, the solid-state battery package more easily maintains its shape.

The thickness of the shape-maintaining layer may be preferably 20 μm to 500 μm, more preferably 20 μm to 300 μm, still more preferably 50 μm to 300 μm, and particularly preferably 50 μm to 150 μm. When the thickness of the shape-maintaining layer is within the above range, the size of the solid-state battery package can be reduced as a whole while further reducing the warpage of the solid-state battery package as a whole. That is, it is easy to obtain a solid-state battery package in which both are more suitably balanced.

### [Covering Portion]

As shown in FIG. 1, the covering portion 60 is provided to cover the main surface 100A and side surface 100B of the solid-state battery 100. As shown in FIG. 1, the covering portion 60 is provided to cover at least the top surface 100A and the side surface 100B of the solid-state battery, and the solid-state battery 100 on the substrate 10 is largely wrapped by the covering portion 60 as a whole. The material of the covering portion 60 may be any type as long as it exhibits insulating properties. For example, the covering portion 60 may contain a resin, and the resin may be either a thermosetting resin or a thermoplastic resin. The covering portion 60 may contain an inorganic filler. Although it is merely an example, the covering portion 60 may be made of an epoxy-based resin containing an inorganic filler such as SiC. As shown in FIG. 1, when the covering portion 60 is regarded as a member covering the periphery of the solid-state battery 100, the covering portion 60 can be said to have an insulating layer covering the solid-state battery 100 and a shape-maintaining layer.

In the solid-state battery package 200 of the present disclosure, the solid-state battery 100 provided on the substrate 10 may be covered with the covering portion 60 to be surrounded as a whole. That is, the solid-state battery 100 on the substrate 10 are packaged such that the top surface 100A and the side surface 100B are surrounded by the covering portion 60. In such a configuration, none of the surfaces of the solid-state battery is exposed to the outside, and water vapor transmission can be prevented.

The solid-state battery package 200 of the present disclosure can be embodied in various embodiments. For example, the following embodiments may be adopted.

As shown in FIG. 3, an embodiment of the present disclosure includes a substrate 10, a solid-state battery 100 provided on the substrate 10, and a covering portion 60 provided to cover the solid-state battery 100, wherein the covering portion 60 includes a shape-maintaining layer 40. In particular, the covering portion 60 includes a covering insulating layer 30 and a covering inorganic layer 50 on the covering insulating layer 30. As a result, the covering insulating layer 30 and the covering inorganic layer 50 are combined with each other to more suitably prevent water vapor transmission. In a preferred embodiment, the shape-maintaining layer 40 is disposed between the covering insulating layer 30 and the covering inorganic layer 50.

FIG. 3 shows an embodiment in which the solid-state battery 100 provided on the substrate 10 is covered with the covering insulating layer 30 and the covering inorganic layer 50 as the covering portion 60. The covering portion 60 may include at least the covering insulating layer 30 and the covering inorganic layer 50 on the covering insulating layer 30.

### [Covering Insulating Layer]

The covering insulating layer 30 may be provided to cover at least the top surface 100A and the side surface 100B of the solid-state battery 100. As illustrated in FIG. 3, the solid-state battery 100 provided on the substrate 10 may be largely wrapped by the covering insulating layer 30 as a whole. In a preferred embodiment, the covering insulating layer 30 is disposed in the whole battery surface region of the top surface 100A and the side surface 100B of the solid-state battery 100 (all of at least the battery “top surface” region and the battery “side surface” region).

The covering insulating layer 30 preferably corresponds to a resin layer. That is, the covering insulating layer 30 contains a resin, which preferably constitutes a base material of the layer. As can be seen from the embodiment illustrated in FIG. 3, this means that the solid-state battery 100 provided on the substrate 10 is sealed with the resin of the covering insulating layer 30. Such a covering insulating layer 30 formed of a resin contributes to a water vapor barrier in combination with the covering inorganic layer 50.

The material of the covering insulating layer may be any type as long as it exhibits insulating properties. For example, when the covering insulating layer contains a resin, the resin may be either a thermosetting resin or a thermoplastic resin. Although not particularly limited, examples of the specific resin of the covering insulating layer include an epoxy-based resin, a silicone-based resin, and/or a liquid crystal polymer. Although it is merely an example, the thickness of the covering insulating layer may be 30 μm to 1000 μm, and is, for example, 50 μm to 300 μm.

The thermal expansion coefficient of the covering insulating layer may be preferably 0.1 ppm/° C. to 50 ppm/° C., more preferably 0.1 ppm/° ° C. to 25 ppm/° C., still more preferably 1 ppm/° C. to 25 ppm/° C., and particularly preferably 1 ppm/° C. to 15 ppm/° C. When the thermal expansion coefficient of the covering insulating layer is within the above range, the effect of preventing the solid-state battery package from being warped as a whole is likely to appear.

The solid-state battery package of the present disclosure may take the following embodiments. For example, in plan view, the outer contour of the shape-maintaining layer 40 and the outer contour of the covering insulating layer 30 may overlap with each other. In other words, in plan view, the side forming the shape-maintaining layer 40 and the side forming the covering insulating layer 30 may overlap with each other. In terms of dimension, in plan view, the shape-maintaining layer 40 may be substantially as long as the covering insulating layer 30 in one direction. The shape-maintaining layer 40 may be substantially as long as the covering insulating layer 30 in the other direction (for example, the direction orthogonal to the one direction). As illustrated in FIG. 3, in the sectional view, the shape-maintaining layer 40 may be substantially as wide as the covering insulating layer 30. By adopting such a configuration, the shape-maintaining layer 40 covers the covering insulating layer 30 as a whole, and thermal expansion and contraction of the covering insulating layer 30 as a whole can be further suppressed. Therefore, warpage deformation due to a difference in thermal expansion and contraction between the members can be more easily suppressed or reduced.

From the viewpoint of further reducing deformation of the solid-state battery package 200, the solid-state battery package of the present disclosure may further take the following embodiments. For example, in plan view, the outer contours of the shape-maintaining layer 40, the covering insulating layer 30, and the substrate 10 may overlap with each other, and the sides forming the shapes of the shape-maintaining layer 40, the covering insulating layer 30, and the substrate 10 may overlap with each other. In terms of dimension, in plan view, the shape-maintaining layer 40, the covering insulating layer 30, and the substrate 10 may be substantially as long as each other in one direction. The shape-maintaining layer 40, the covering insulating layer 30, and the substrate 10 may be substantially as long as each other in the other direction (for example, the direction orthogonal to the one direction). As illustrated in FIG. 3, in the sectional view, the shape-maintaining layer 40, the covering insulating layer 30, and the substrate 10 may be substantially as wide as each other. By adopting such a configuration, the shape-maintaining layer 40 covers the covering insulating layer 30 as a whole, and thermal expansion and contraction of the covering insulating layer 30 as a whole can be further suppressed. Furthermore, since the shape-maintaining layer 40 can have the same dimension as the substrate 10, the deformation amount when the shape-maintaining layer 40 and the substrate 10 thermally expand and contract is substantially equal. Therefore, the difference in thermal expansion and contraction between the shape-maintaining layer 40 and the substrate 10 may be further reduced. Therefore, warpage deformation due to a difference in thermal expansion and contraction between the members can be more easily suppressed or reduced.

From the viewpoint of further reducing deformation of the solid-state battery package, the covering insulating layer and the shape-maintaining layer may have the following relationship.

The thermal expansion coefficient of the shape-maintaining layer may be smaller than the thermal expansion coefficient of the covering insulating layer. Specifically, the thermal expansion coefficient of the shape-maintaining layer may be smaller than the thermal expansion coefficient of the covering insulating layer in a range of 10 ppm/° C. to 50 ppm/° C., preferably in a range of 20 ppm/° C. to 50 ppm/° C., and more preferably in a range of 30 ppm/° C. to 50 ppm/° C. When the thermal expansion coefficient of the shape-maintaining layer is within the above range, the difference in thermal expansion and contraction between the members of the solid-state battery package is more likely to be reduced. The warpage of the solid-state battery package as a whole is more easily suppressed or reduced.

The shape-maintaining layer itself may be a layer that is less likely to deform compared to other package components. For example, the shape-maintaining layer may have rigidity higher than the covering insulating layer. In a preferred embodiment, the shape-maintaining layer has a Young's modulus higher than that of the covering insulating layer. For example, the Young's modulus of the shape-maintaining layer may be higher than the Young's modulus of the covering insulating layer in a range of 1 GPa to 450 GPa, preferably 10 GPa to 450 GPa, more preferably 50 GPa to 450 GPa, and still more preferably 100 GPa to 450 GPa. By providing the shape-maintaining layer having a Young's modulus within the above range in the solid-state battery package, the rigidity of the covering insulating layer can be enhanced by the shape-maintaining layer present therein, so that deformation of the solid-state battery package can be more easily suppressed.

### [Covering Inorganic Layer]

The covering inorganic layer 50 is provided to cover the covering insulating layer 30. As shown in FIG. 3, the covering inorganic layer 50 is positioned on the covering insulating layer 30, and thus has a form of largely enclosing the solid-state battery 100 on the substrate 10 as a whole together with the covering insulating layer 30.

The covering inorganic layer 50 preferably has a thin film form. The material of the covering inorganic layer 50 is not particularly limited as long as it contributes to an inorganic layer having a thin film form, and may be metal, glass, oxide ceramics, a mixture thereof, or the like. In a preferred embodiment, the covering inorganic layer 50 contains a metal component. That is, the covering inorganic layer 50 is preferably a metal thin film. Although it is merely an example, the thickness of such a covering inorganic layer may be 0.1 μm to 100 μm, and is, for example, 1 μm to 50 μm. The covering inorganic layer 50 can be referred to as a covering inorganic film due to its thickness.

In particular, depending on the production method, the covering inorganic layer 50 may be a dry plating film. Such a dry plating film is a film obtained by a vapor phase method such as physical vapor deposition (PVD) or chemical vapor deposition (CVD), and has a very small thickness on the nano order or the micron order. Such a thin dry plating film contributes to more compact packaging.

The dry plating film may contain, for example, at least one metal component/metalloid component selected from the group consisting of aluminum (Al), nickel (Ni), palladium (Pd), silver (Ag), tin (Sn), gold (Au), copper (Cu), titanium (Ti), platinum (Pt), silicon (Si), SUS, and the like, an inorganic oxide, a glass component, and/or the like. Since the dry plating film containing such a component is chemically and/or thermally stable, a solid-state battery having excellent chemical resistance, weather resistance, heat resistance, and/or the like and further improved long-term reliability can be provided.

The covering inorganic layer 50 can function as a water vapor barrier film. That is, the covering inorganic layer 50 covers the top surface 100A and the side surface 100B of the solid-state battery 100 so as to serve as a barrier that prevents moisture from entering the solid-state battery 100. The “barrier” as used herein broadly means having a characteristic of blocking the water-vapor transmission such that water vapor in the external environment does not permeate the covering inorganic layer to cause degradation of characteristics that is inconvenient to the solid-state battery, and narrowly means having a water-vapor transmission rate of less than 5.0×10⁻³ g/(m²·Day). Therefore, in short, the water vapor barrier film preferably has a water-vapor transmission rate of 0 to less than 5×10⁻³ g/(m²·Day). The term “water-vapor transmission rate” as used herein refers to a transmission rate obtained by the MA method under measurement conditions of 85° C. and 85% RH using a gas transmission rate measuring device of model WG-15S manufactured by MORESCO Corporation.

The covering inorganic layer 50 may be a sputtered film. In other words, a sputtered thin film is provided as a dry plating film provided to cover the covering insulating layer 30.

The sputtered film is a thin film obtained by sputtering. In other words, a film in which ions are sputtered onto a target to knock out the atoms and deposit them on the covering insulating layer 30 is used as the covering inorganic thin film.

This sputtered film becomes a dense and/or homogeneous film while having a significantly thin form on the nano-order or micro-order, and is thus preferable as a water vapor transmission barrier for solid-state batteries. The sputtered film is formed by atomic deposition, thus has a relatively high adhesive force and may be more suitably integrated with the covering inorganic thin film. Hence, the sputtered film is likely to constitute a water vapor barrier film for the solid-state battery together with the covering insulating layer 30. In other words, the sputtered film provided to cover at least the top surface 100A and side surface 100B of the solid-state battery together with the covering insulating layer 30 may be used as a barrier to prevent water vapor in the external environment from entering the solid-state battery.

In a suitable embodiment, the sputtered film contains at least one selected from the group consisting of, for example, Al (aluminum), Cu (copper), and Ti (titanium), and the thickness thereof is 1 μm to 100 μm, for example, 5 μm to 50 μm. Although not particularly limited, it is preferable that the sputtered film has substantially the same thickness both at a local place positioned on the top surface of the solid-state battery and a local place positioned on the side surface of the solid-state battery. This is because penetration of water vapor in the external environment into the battery can be more uniformly prevented as the whole package product.

A dry plating film represented by such a sputtered film can be realized in a more suitable thickness from the viewpoint of water vapor barrier. For example, the dry plating film can be provided as a thicker film by relatively increasing the number of sputterings, while the dry plating film can also be provided as a thinner film by relatively decreasing the number of sputterings. For example, the dry plating film can be used as a covering inorganic layer having a laminated structure by changing the kind of target at the time of sputtering. In other words, the covering inorganic layer can also be provided as a multiple-layer structure including at least two layers. The multiple-layer structure is not particularly limited to different materials, but may be the same material.

A wet plating film may be disposed on the dry plating film. The wet plating film is generally formed at a higher deposition rate than the dry plating film. Therefore, when a film having a large thickness is disposed as the covering inorganic layer, the film may be formed efficiently by combining the dry plating film with the wet plating film.

### [Substrate]

In the solid-state battery package 200 of the present disclosure, the substrate 10 may be a packaging member provided to support the solid-state battery 100. That is, the substrate 10 provided more proximal to one main surface side (the main surface opposite to the main surface forming the top surface) of the solid-state battery 100 may be a support substrate. As shown in FIG. 1, the substrate 10 has a main surface larger than, for example, the solid-state battery 100. The substrate 10 may be a resin substrate or a ceramic substrate. In short, the substrate 10 may belong to a printed circuit board, a flexible substrate, an LTCC substrate, an HTCC substrate, or the like.

When the substrate 10 is a ceramic substrate, the substrate 10 includes a ceramic, and the ceramic occupies the base material component of the substrate. The substrate formed from ceramic contributes to prevention of water vapor transmission, and is thus a preferred substrate in terms of heat resistance and the like in substrate mounting. Such a ceramic substrate can be obtained by firing and can be obtained by firing, for example, a green sheet laminate.

The substrate 10 preferably serves as a member for an external terminal of the packaged solid-state battery. More particularly, the substrate 10 can be also considered as a terminal substrate for an external terminal of the solid-state battery 100. In the solid-state battery package including such a substrate, the solid-state battery can be mounted on another secondary substrate such as a printed wiring board with the substrate interposed therebetween. For example, the solid-state battery can be surface-mounted with the substrate interposed therebetween, through solder reflow and the like. For the reasons described above, the solid-state battery package according to the present disclosure is preferably a surface-mount-device (SMD) type battery package.

Since the substrate is a terminal substrate, the substrate preferably has wiring, an electrode layer, and the like. Especially, the substrate may have an electrode layer electrically connecting the upper and lower main surfaces. That is, the substrate 10 according to a preferred embodiment includes an electrode layer that electrically connects the upper and lower main surfaces of the substrate, and is a member for an external terminal of the solid-state battery package 200. In the solid-state battery package 200 including such a substrate, the electrode layer of the substrate and the terminal portion of the solid-state battery are connected to each other. Specifically, the electrode layer of substrate 10 and the end-face electrode 140 of the solid-state battery 100 are electrically connected to each other. For example, the positive-electrode-side end-face electrode of the solid-state battery is electrically connected to the positive-electrode-side electrode layer of the substrate, while the negative-electrode-side end-face electrode of the solid-state battery is electrically connected to the negative-electrode-side electrode layer of the substrate. With such electrical connection, the electrode layers on the positive-electrode-side and the negative-electrode-side of the substrate are provided as a positive electrode terminal and a negative electrode terminal of the solid-state battery package 200, respectively.

The thermal expansion coefficient of the substrate (particularly the base material of the substrate) may be preferably 0.1 ppm/° C. to 50 ppm/° C., more preferably 0.1 ppm/° C. to 25 ppm/° C., still more preferably 5 ppm/° C. to 25 ppm/° C., and particularly preferably 5 ppm/° C. to 15 ppm/° C. When the thermal expansion coefficient of the substrate is within the above range, the difference in thermal expansion and contraction between the substrate and the shape-maintaining layer is more easily reduced. That is, the effect of preventing the solid-state battery package as a whole from being warped becomes more apparent.

The thickness of the substrate may be preferably 20 μm to 500 μm, more preferably 20 μm to 300 μm, still more preferably 50 μm to 300 μm, and particularly preferably 50 μm to 200 μm. When the thickness of the substrate 10 is within the above range, the total size of the solid-state battery package 200 can be reduced while further suppressing or reducing warpage of the solid-state battery package as a whole. That is, it is easy to obtain a solid-state battery package in which both are suitably balanced.

From the viewpoint of further reducing deformation of the solid-state battery package, the solid-state battery package of the present disclosure may take the following embodiments. For example, in plan view, the outer contour of the shape-maintaining layer 40 and the outer contour of the substrate 10 may overlap with each other. In other words, in plan view, the side forming the shape-maintaining layer 40 and the side forming the substrate 10 may overlap with each other. In terms of dimension, in plan view, the shape-maintaining layer 40 may be substantially as long as the substrate 10 in one direction. The shape-maintaining layer 40 may be substantially as long as the substrate 10 in the other direction (for example, the direction orthogonal to the one direction). In a sectional view, the shape-maintaining layer 40 may be substantially as wide as the substrate 10. By adopting such a configuration, the shape-maintaining layer 40 can have the same dimension as that of the substrate 10, and thus the deformation amount when the shape-maintaining layer 40 and the substrate 10 thermally expand and contract becomes substantially equal. Therefore, the difference in thermal expansion and contraction between the shape-maintaining layer 40 and the substrate 10 may be further reduced. Therefore, warpage deformation due to a difference in thermal expansion and contraction between members is more easily suppressed or reduced.

When the substrate 10 is a ceramic substrate, the effect of preventing water vapor transmission through the substrate 10 is easily exhibited. When the substrate has a water vapor barrier property, as shown in FIG. 3, water vapor transmission from the upper side and the lateral side of the solid-state battery 100 may be prevented mainly by the covering insulating layer 30 and the covering inorganic layer 50, while water vapor transmission from the lower side (bottom side) of the solid-state battery 100 may be prevented mainly by the substrate 10. Considering that the substrate 10 is preferably a terminal substrate, it can be said that the water vapor transmission prevention from the lower side (bottom side) of the solid-state battery 100 is performed mainly by the terminal substrate.

In an embodiment of the present disclosure, the substrate 10 may have a form of a multilayer wiring board. That is, the solid-state battery may be supported by a substrate in which the wiring has a plurality of layers. For example, as illustrated in FIG. 4, the substrate 10 may include a multilayer wiring board having at least an inner via hole 14. In the illustrated substrate 10, that is, the substrate 10, wiring layers 15 is formed inside the substrate, and the upper and lower wiring layers 15 are connected to each other by the inner via hole 14. The substrate 10 including the multilayer wiring as described above increases the design freedom of the external terminal as a package. In other words, the external terminal can be positioned at an arbitrary place in the bottom surface of the battery package product.

The present disclosure can be embodied in various embodiments.

### <<Embodiment to Suppress Deformation During Manufacturing>>

In such an embodiment, deformation of the solid-state battery package and/or the constituent members, which may occur during manufacturing, is reduced by the shape-maintaining layer. For example, during manufacturing, a step of forming a member constituting the solid-state battery package or the like may be accompanied by a thermal change to cause a difference in thermal expansion and contraction between the package components. The difference in thermal expansion and contraction during such a step may be a factor of deformation of the solid-state battery package and/or the constituent members. Therefore, by providing the shape-maintaining layer for manufacturing the package, deformation caused by a difference in thermal expansion and contraction during manufacturing is suppressed or reduced. Examples of embodiments during manufacturing can include, for example, the following.

### (Embodiment to Suppress Deformation During Resin Curing)

While the solid-state battery package may include resin members, the formation thereof may generally involve thermal changes, resulting in a difference in thermal expansion and contraction between the package components. For example, heat treatment or the like may be performed so that the resin member is formed by curing, which may cause a difference in thermal expansion and contraction between the package components.

When the covering portion of the solid-state battery package is composed of a covering insulating layer and a covering inorganic layer, and the covering insulating layer is provided as a resin layer, the resin layer may be formed by curing a precursor thereof. In such a case, the shape-maintaining layer may be provided in the precursor of the resin layer, and the precursor of the resin layer may be cured together with the shape-maintaining layer. When such a covering insulating layer is formed, the shape-maintaining layer is present. Therefore, package deformation caused by a difference in thermal expansion and contraction when the covering insulating layer is formed from the precursor is suppressed or reduced.

### <<Embodiment to Suppress Deformation During Surface-Mounting>>

When the solid-state battery package is surface-mounted on an external substrate, heating treatment such as reflow treatment is performed. That is, the reflow treatment generally involves thermal changes and may result in a difference in thermal expansion and contraction between the package components. For example, in the reflow treatment for mounting the solid-state battery package on an external substrate via solder, the peak temperature reaches a temperature as high as about 260° C. Therefore, a large temperature change can be caused in the solid-state battery package during the reflow treatment.

Since the solid-state battery package of the present disclosure is provided with the shape-maintaining layer therein, deformation is suppressed or reduced when the reflow treatment causes such a large temperature change. That is, the shape-maintaining layer included in the solid-state battery package more effectively suppresses or reduces package deformation and the like caused by a difference in thermal expansion and contraction during the reflow treatment.

### <<Embodiment to Suppress Deformation During Use>>

The solid-state battery package is charged and discharged for use, or is placed in a high temperature environment or a low temperature environment.

For example, during charging, heat may be generated due to an electrochemical reaction between the electrodes of the solid-state battery, and the solid-state battery package is accompanied by a thermal change. That is, during charging, such a thermal change may cause a difference in thermal expansion and contraction between the package components. Since the solid-state battery package of the present disclosure is provided with the shape-maintaining layer therein, such deformation due to temperature change during charging is suppressed or reduced. That is, the shape-maintaining layer included in the solid-state battery package more effectively suppresses or reduces package deformation and the like caused by a difference in thermal expansion and contraction during charging.

Also, when the solid-state battery package is placed in a higher temperature environment or a lower temperature environment, the solid-state battery package is accompanied by a thermal change. That is, a difference in thermal expansion and contraction may be caused between the package components by a thermal change caused by a temperature environment where the solid-state battery package is used. In this regard, since the solid-state battery package of the present disclosure is provided with the shape-maintaining layer therein, such deformation caused by the temperature change in the surrounding environment is suppressed or reduced. That is, the shape-maintaining layer included in the solid-state battery package more effectively suppresses or reduces package deformation and the like caused by a difference in thermal expansion and contraction due to a temperature environmental change.

### [Method for Manufacturing Solid-State Battery Package]

The packaged product according to the present disclosure can be obtained through a process of preparing a solid-state battery that includes a battery constituent unit including a positive electrode layer, a negative electrode layer, and a solid electrolyte between the electrodes and next packaging the solid-state battery.

The manufacture of the solid-state battery package according to the present disclosure can be roughly divided into: manufacturing a solid-state battery itself corresponding to one before packaging (hereinafter, also referred to as an “unpackaged battery”); preparing a substrate; and packaging.

### <<Method for Manufacturing Unpackaged Battery>>

The unpackaged battery can be manufactured by a printing method such as screen printing, a green sheet method using a green sheet, or a combined method thereof. More particularly, the unpackaged battery itself may be fabricated in accordance with a conventional method for manufacturing a solid-state battery (thus, for raw materials such as the solid electrolyte, organic binder, solvent, optional additives, positive electrode active material, and negative electrode active material described below, those for use in the manufacture of known solid-state batteries may be used).

Hereinafter, for better understanding of the present disclosure, one manufacturing method will be exemplified and described, but the present disclosure is not limited to this method. In addition, the following time-dependent matters such as the order of descriptions are merely considered for convenience of explanation, and the present disclosure is not necessarily bound by the matters.

### (Formation of Stack Block)

The solid electrolyte, the organic binder, the solvent, and optional additives are mixed to prepare a slurry. Then, from the prepared slurry, sheets including the solid electrolyte are formed by firing.

The positive electrode active material, the solid electrolyte, the conductive material, the organic binder, the solvent, and optional additives are mixed to prepare a positive electrode paste. Similarly, the negative electrode active material, the solid electrolyte, the conductive material, the organic binder, the solvent, and optional additives are mixed to prepare a negative electrode paste.

The positive electrode paste is applied by printing onto the sheet, and a current collecting layer and/or a negative layer are applied by printing, if necessary. Similarly, the negative electrode paste is applied by printing onto the sheet, and a current collecting layer and/or a negative layer are applied by printing, if necessary.

The sheet with the positive electrode paste applied by printing and the sheet with the negative electrode paste applied by printing are alternately stacked to obtain a stacked body. Further, the outermost layer (the uppermost layer and/or the lowermost layer) of the stacked body may be an electrolyte layer, an insulating layer, or an electrode layer.

### (Formation of Battery Fired Body)

The stacked body is integrated by pressure bonding, and then cut into a predetermined size. The cut stacked body obtained is subjected to degreasing and firing. Thus, a fired stacked body is obtained. The stacked body may be subjected to degreasing and firing before cutting, and then cut.

### (Formation of End-Face Electrode)

The end-face electrode on the positive electrode side can be formed by applying a conductive paste to the positive electrode-exposed side surface of the fired stacked body. Similarly, the end-face electrode on the negative electrode side can be formed by applying a conductive paste to the negative electrode-exposed side surface of the fired stacked body. The end-face electrodes on the positive electrode side and the negative electrode side may be provided so as to extend to the main surface of the fired stacked body. This is because it is possible to connect to the main surface electrode layer of the substrate in a small area in the next step (More specifically, the end-face electrode provided so as to extend to the main surface of the fired stacked body has a folded portion on the main surface, and such a folded portion can be electrically connected to the main surface electrode layer of the substrate). The component for the end-face electrode can be selected from at least one selected from silver, gold, platinum, aluminum, copper, tin, and nickel.

Further, the end-face electrodes on the positive electrode side and the negative electrode side are not limited to being formed after firing the stacked body, and may be formed before the firing and subjected to simultaneous firing.

By carrying out the steps as described above, a desired unpackaged battery can be finally obtained.

### <<Preparation of Substrate>>

### (Resin Substrate)

When the substrate is a resin substrate, it may be prepared by stacking a plurality of layers and performing heating and pressure treatment. For example, at least one resin sheet constituted by impregnating a fiber cloth and/or paper as a base material with a resin raw material and at least one metal sheet (for example, a metal foil sheet) are prepared, and stacked with each other to form a substrate precursor. Then, the substrate precursor is subjected to heating and pressurization in a press machine to obtain a resin substrate.

The main surface electrode layer provided on the main surface of the substrate to be electrically connected may be appropriately subjected to patterning processing.

### (Ceramic Substrate)

When the substrate is a ceramic substrate, it may be prepared, for example, by stacking and firing a plurality of green sheets.

The ceramic substrate may have vias and/or lands. In such a case, for example, holes may be formed in the green sheet with a punch press, a carbon dioxide laser, or the like, and the holes may be filled with a conductive paste material; or through performing a printing method or the like, the precursor of a conductive portion/wiring such as a via, a land, and/or a wiring layer may be formed. Subsequently, a predetermined number of such green sheets are stacked and thermocompression bonded to form a green sheet laminate, and the green sheet laminate is subjected to firing, whereby the ceramic substrate can be obtained. Further, lands and the like can also be formed after firing the green sheet laminate.

By carrying out the steps as described above, a desired substrate can be finally obtained.

### <<Packaging>>

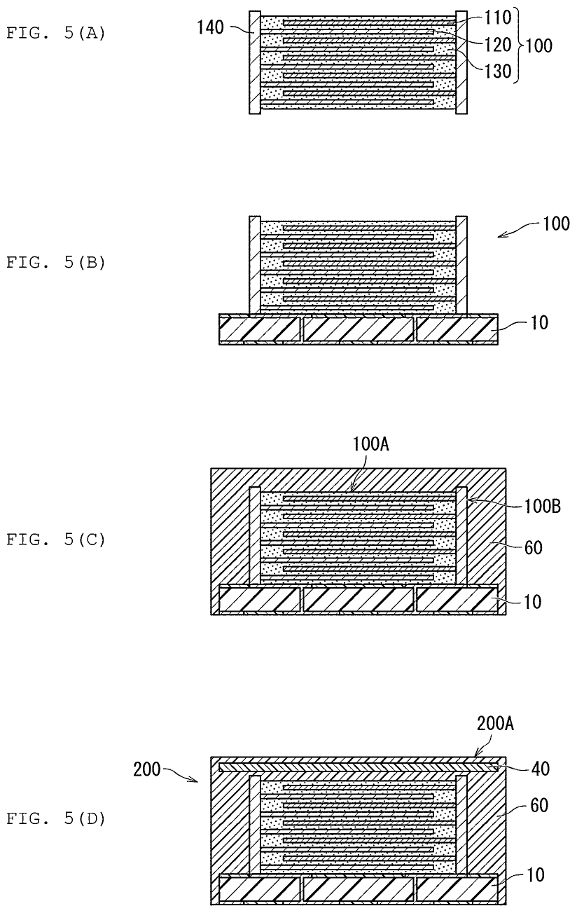

In packaging, the battery and the substrate obtained above are used. FIGS. 5(A) to 5(D) schematically illustrates a step of obtaining the solid-state battery according to the present disclosure by packaging.

First, as illustrated in FIGS. 5(A) and 5(B), the unpackaged battery 100 is placed on the substrate 10. More particularly, the “unpackaged solid-state battery” is placed on the substrate 10 (hereinafter, the battery used for packaging is also simply referred to as a “solid-state battery”).

Preferably, the solid-state battery 100 is placed on the substrate 10 so as to electrically connect the conductive parts of the substrate 10 and the end-face electrodes of the solid-state battery 100 to each other. In an embodiment, a conductive paste may be provided on the substrate 10, thereby electrically connect the conductive parts of the substrate 10 and the end-face electrodes of the solid-state battery 100 to each other. More specifically, alignment may be performed such that the positive-electrode-side mounting land on the substrate surface matches the folded portion of the positive-electrode-side end-face electrode of the solid-state battery 100, and the negative-electrode-side mounting land matches the folded portion of the negative-electrode-side end-face electrode of the solid-state battery, and bonding and connection may be performed using a conductive paste (for example, Ag conductive paste). As such a bonding material, any conductive paste that does not require flux cleaning or the like after formation, such as nanopaste, alloy-based paste, or brazing material, can be used in addition to the Ag conductive paste.

Next, as shown in FIG. 5(C), a covering portion 60 is provided to cover the solid-state battery 100 on the substrate 10. Specifically, the covering portion 60 is provided to cover the top surface 100A and the side surface 100B of solid-state battery 100 disposed on the substrate 10.

After the covering portion 60 is provided, as shown in FIG. 5(D), a shape-maintaining layer 40 is provided in the covering portion 60. When the shape-maintaining layer 40 contains a resin, a shape-maintaining layer precursor may be provided instead of the shape-maintaining layer 40. In an embodiment, when the shape-maintaining layer 40 is provided in the covering portion 60, the shape-maintaining layer 40 may be provided above the solid-state battery 100. The place where the shape-maintaining layer 40 is provided is not particularly limited, as long as it is above the solid-state battery 100. For example, a part of the shape-maintaining layer 40 may be buried and positioned in the top surface 200A of the solid-state battery package 200. Alternatively, the shape-maintaining layer 40 may be positioned such that the shape-maintaining layer 40 is buried in the covering portion 60 as a whole. When the shape-maintaining layer 40 is buried and positioned in the covering portion 60 as a whole, for example, the shape-maintaining layer 40 may be positioned relatively proximal to the top surface 200A of the solid-state battery package 200, or the shape-maintaining layer 40 may be positioned relatively proximal to the solid-state battery 100.

After the shape-maintaining layer 40 is provided to the covering portion 60, the covering portion 60 and the shape-maintaining layer 40 are simultaneously thermally cured. In a preferred embodiment, the covering portion 60 may be molded by applying pressure with a mold.

When a covering insulating layer 30 and a covering inorganic layer 50 are used as the covering portion 60, the following embodiment can be adopted.

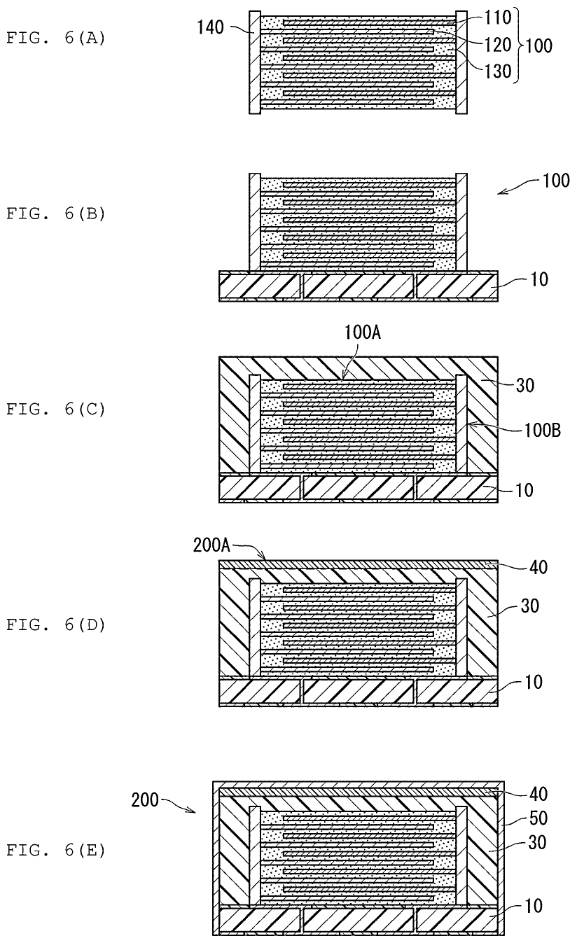

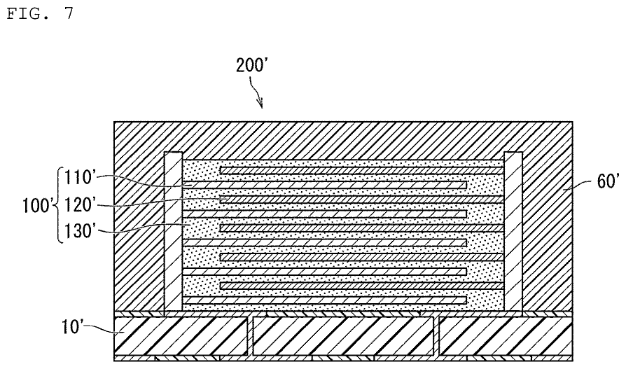

FIGS. 6(A) to 6(B) are steps similar to those in FIGS. 5(A) to 5(B) described above. That is, the solid-state battery 100 disposed on the substrate 10 is obtained through the steps of FIGS. 6(A) to 6(B).

Next, as shown in FIG. 6(C), a covering insulating layer 30 is provided to cover the solid-state battery 100 on the substrate 10. Specifically, the covering insulating layer 30 is provided to cover the top surface 100A and the side surface 100B of the solid-state battery 100 disposed on the substrate 10. When the covering insulating layer 30 contains a resin, a covering insulating layer precursor may be provided on the substrate 10 instead of the covering insulating layer 30.

After the covering insulating layer 30 is provided, as shown in FIG. 6(D), the shape-maintaining layer 40 is provided in the covering insulating layer 30. When the shape-maintaining layer 40 contains a resin, a shape-maintaining layer precursor may be provided instead of the shape-maintaining layer 40. In an embodiment, when the shape-maintaining layer 40 is provided in the covering insulating layer 30, the shape-maintaining layer 40 may be provided above the solid-state battery 100. The place where the shape-maintaining layer 40 is provided is not particularly limited, as long as it is above the solid-state battery 100. For example, a part of the shape-maintaining layer 40 may be buried and positioned in the top surface 200A of the solid-state battery package 200. Alternatively, the shape-maintaining layer 40 may be positioned such that the shape-maintaining layer 40 is buried in the covering insulating layer 30 as a whole. When the shape-maintaining layer 40 is buried and positioned in the covering insulating layer 30 as a whole, for example, the shape-maintaining layer 40 may be positioned relatively proximal to the top surface 200A of the solid-state battery package 200, or the shape-maintaining layer 40 may be positioned relatively proximal to the solid-state battery 100. In another embodiment, the shape-maintaining layer 40 may be provided such that the substrate 10 on which the solid-state battery 100 is placed and the shape-maintaining layer 40 are parallel to each other.

In an embodiment of the present disclosure, in plan view, the shape-maintaining layer may be provided such that the outer contour of the shape-maintaining layer 40 and the outer contour of the covering insulating layer 30 overlap with each other. Alternatively, in a sectional view, the shape-maintaining layer 40 may be provided such that the shape-maintaining layer 40 reaches the outer surface of the covering insulating layer 30 covering the side surface 100B of the solid-state battery 100.

After the shape-maintaining layer 40 is provided to the covering insulating layer 30, the covering insulating layer 30 and the shape-maintaining layer 40 are simultaneously thermally cured. According to a preferred embodiment, the covering insulating layer 30 may be molded by pressurization with a mold. By way of example only, the covering insulating layer 30 to seal the solid-state battery 100 on the substrate 10 may be molded through compression molding.

In a case of a resin generally for use in molding, the form of the raw material for the covering insulating layer 30 may be granular, and the type thereof may be a thermosetting resin or a thermoplastic resin. Such molding is not limited to die molding, and may be performed through polishing processing, laser processing, and/or chemical treatment.

The following embodiment can also be adopted instead of FIG. 6(D). For example, after the shape-maintaining layer having a thermal expansion coefficient close to that of the substrate 10 is fixed so as to be parallel to the substrate 10 on which the solid-state battery 100 is placed, the covering insulating layer 30 may be formed to cover the solid-state battery 100 on the substrate 10, and the shape-maintaining layer and the covering insulating layer 30 may be thermally cured simultaneously.

Next, as shown in FIG. 6(E), a covering inorganic layer 50 is formed. Specifically, the covering inorganic layer 50 is formed on the “covering precursor in which each solid-state battery 100 on the substrate 10 is provided with a covering insulating layer 30 and a shape-maintaining layer 40”. For example, dry plating may be performed to form a dry plating film as the covering inorganic layer. More specifically, dry plating is performed to form the covering inorganic layer on the exposed surface other than the bottom surface of the covering precursor (that is, other than the bottom surface of the substrate). In a preferred embodiment, sputtering is performed to form a sputtered film on the exposed outer surface other than the bottom surface of the covering precursor.

Through the above steps, it is possible to obtain a solid-state battery package in which the shape-maintaining layer 40 is disposed between the covering insulating layer 30 and the covering inorganic layer 50. More particularly, the “solid-state battery package” according to the present disclosure can be finally obtained.

In the above description, an embodiment in which the covering insulating layer is molded so as to largely seal the solid-state battery on the substrate through compression/molding has been described as an example, but the present disclosure is not particularly limited thereto. The covering insulating layer may be formed by a coating method such as spray atomization. In the case of using a coating method, the shape of the covering insulating layer 30 in a sectional view may relatively largely reflect the contours of the substrate and the solid-state battery thereon. In this case, the shape of the covering inorganic layer 50 provided on the covering insulating layer in a sectional view may also relatively largely reflect the contours of the substrate and the solid-state battery thereon.

Although the embodiments of the present disclosure have been described above, only typical examples have been illustrated. Those skilled in the art will easily understand that the present disclosure is not limited thereto, and various embodiments are conceivable without changing the gist of the present disclosure.

For example, the solid-state battery package may expand and contract during charging and discharging, but the shape-maintaining layer can suppress or reduce a disadvantageous phenomenon due to such expansion and contraction. Specifically, when the packaged solid-state battery expands, a load is applied to the package members due to the expansion, and a crack or the like may occur in the package members. In this regard, the solid-state battery package of the present disclosure, including the shape-maintaining layer, can suppress or reduce cracks and the like in the package due to expansion and contraction during charging and discharging.

### EXAMPLES

A demonstration test was conducted according to the present disclosure. The structure of the solid-state battery package adopted the structure of FIG. 3. Further, as a process for obtaining the solid-state battery package, the process of FIGS. 6(A) to 6(E) was adopted. In the demonstration test, the number of elements of 209 was collectively prepared in a substrate size of 130 mm×130 mm. Thereafter, the substrate was cut into individual pieces.

Specifically, the solid-state battery packages including the substrate and the shape-maintaining layer described in Comparative Example 1 and Examples 1 to 3 shown in Table 1 below were manufactured. A glass epoxy substrate (4 layers, with Cu foil) was used as a substrate, and a single-layer substrate of FR-4 (without copper foil) and a copper foil were used as the shape-maintaining layer.

TABLE 1

| | | | Substrate | | Shape- |
|---|---|---|---|---|---|
| | | | linear | | maintaining |
| | | Substrate | expansion | Shape- | layer |
| | | thickness | coefficient | maintaining | thickness |
| | Substrate | (mm) | (ppm/° C.) | layer | (mm) |
| Comparative | FR-4 | 0.17 | 10 | None | — |
| Example 1 | | | | | |
| Example 1 | FR-4 | 0.17 | 10 | FR-4 | 0.10 |
| Example 2 | FR-4 | 0.17 | 10 | FR-4 | 0.10 |
| Example 3 | FR-4 | 0.17 | 10 | Copper | 0.035 |
| | | | | foil | |

| | Shape- | | | |
|---|---|---|---|---|
| | maintaining | Shape- | | |
| | layer | maintaining | | |
| | linear | layer | | Substrate |
| | expansion | Young's | Deformation | amount of |
| | coefficient | modulus | amount | warpage |
| | (ppm/° C.) | (GPa) | (μm) | (mm) |
| Comparative | — | — | 69.2 | 11.5 |
| Example 1 | | | | |
| Example 1 | 10 | 20 | 32.5 | 0.3 |
| Example 2 | 13 | 20 | 33.2 | 0.4 |
| Example 3 | 17 | 110 | 29.5 | 0.3 |

As the values of the linear expansion coefficient and the Young's modulus of the FR-4 substrate used in the substrate and the shape-maintaining layer, values obtained by a method in accordance with JIS standard JIS C 6481 “Test methods of copper-clad laminates for printed wiring boards” were used.

The thickness of the substrate and the shape-maintaining layer were measured before manufacturing the solid-state battery package, but the thickness may be determined from a section processed using an ion milling apparatus (model number SU-8040; manufactured by Hitachi High-Tech Corporation) after manufacturing the solid-state battery package.

Generation of warpage in the solid-state battery packages of Comparative Example and Examples was evaluated. The amount of warpage of the manufactured solid-state battery package (element size: 130 mm×130 mm) including a plurality of battery elements was measured using a laser displacement meter.

Next, in order to evaluate the occurrence of warpage due to heat, the solid-state battery package (element size: 6 mm×10 mm) after being cut into individual pieces was measured for the amount of deformation at 25° C. and 260° C. by the shadow moire method in terms of coplanarity at each temperature. The difference in the maximum displacement amount at each temperature was calculated and defined as the thermal deformation amount.

According to the above results, in comparison between the solid-state battery package of Examples 1 to 3 and the solid-state battery package of Comparative Example 1, Examples, in each of which the shape-maintaining layer was used, achieved a result that the amount of warpage of the package and the warpage due to heat were reduced. Therefore, the shape-maintaining layer present in the covering portion covering the solid-state battery suppresses or reduces warpage, distortion, and the like of the solid-state battery package as a whole due to heat or the like. That is, the shape-maintaining layer included in the solid-state battery package of the present disclosure suppresses or reduces deformation of the solid-state battery package due to a difference in thermal expansion and contraction.

The packaged solid-state battery of the present disclosure can be utilized in various fields where battery use and power storage are assumed. The packaged solid-state battery according to the present disclosure is usable in electronics mounting fields (just an example). In addition, the electrode according to the present disclosure is usable in electric/information/communication fields where a mobile device or the like is used (e.g., mobile device fields of a mobile phone, a smartphone, a laptop computer, a digital camera, an activity meter, an arm computer, electronic paper, and the like), home and small industrial applications (e.g., fields of an electric tool, a golf cart, and a home/care/industrial robot), large industrial applications (e.g., fields of a forklift, an elevator, and a bay harbor crane), transportation system fields (e.g., fields of a hybrid vehicle, an electric vehicle, a bus, a train, an electric assist bicycle, an electric motorcycle, and the like), power system applications (e.g., fields of various types of power generation, a road conditioner, a smart grid, a general home-installed power storage system, and the like), medical applications (medical device fields of an earphone hearing aid and the like), medicinal applications (fields of a dose management system and the like), IoT fields, space/deep sea applications (e.g., fields of a spacecraft, a submersible research vessel, and the like), and the like.

### DESCRIPTION OF REFERENCE SYMBOLS

10: Substrate
14: Inner via hole
15: Wiring layer
30: Covering insulating layer
40: Shape-maintaining layer
50: Covering inorganic layer
60: Covering portion
100: Solid-state battery
100A: Top surface of solid-state battery
100B: Side surface of solid-state battery
110: Positive electrode layer
120: Negative electrode layer
130: Solid electrolyte or solid electrolyte layer
140: End-face electrode
200: Solid-state battery package
200A: Top surface of solid-state battery package

1. A solid-state battery package comprising:
a substrate;
a solid-state battery on the substrate;
a covering portion covering the solid-state battery; and
a shape-maintaining layer in contact with the covering portion.

2. The solid-state battery package according to claim 1, wherein the shape-maintaining layer is positioned such that the solid-state battery is between the substrate and the shape-maintaining layer.

3. The solid-state battery package according to claim 1, wherein a thermal expansion coefficient of the shape-maintaining layer is 0.7 times to 1.3 times a thermal expansion coefficient of the substrate.

4. The solid-state battery package according to claim 1, wherein the shape-maintaining layer and the substrate are disposed in parallel to each other.

5. The solid-state battery package according to claim 1, wherein the shape-maintaining layer is in a layer of the covering portion further from the substrate than the solid-state battery.

6. The solid-state battery package according to claim 1, wherein the covering portion is on the shape-maintaining layer.

7. The solid-state battery package according to claim 1, wherein the shape-maintaining layer is buried in the covering portion.

8. The solid-state battery package according to claim 1, wherein the covering portion has:
a covering insulating layer; and
a covering inorganic layer located outside the covering insulating layer, and
the shape-maintaining layer is between the covering insulating layer and the covering inorganic layer.

9. The solid-state battery package according to claim 8, wherein a thermal expansion coefficient of the shape-maintaining layer is smaller than a thermal expansion coefficient of the covering insulating layer.

10. The solid-state battery package according to claim 8, wherein the shape-maintaining layer has a rigidity higher than that of the covering insulating layer.

11. The solid-state battery package according to claim 1, wherein the covering portion is a covering insulating layer.

12. The solid-state battery package according to claim 11, wherein a thermal expansion coefficient of the shape-maintaining layer is smaller than a thermal expansion coefficient of the covering insulating layer.

13. The solid-state battery package according to claim 11, wherein the shape-maintaining layer has a rigidity higher than that of the covering insulating layer.

14. The solid-state battery package according to claim 1, wherein the shape-maintaining layer contains a resin.

15. The solid-state battery package according to claim 1, wherein the shape-maintaining layer contains a filler.

16. The solid-state battery package according to claim 1, wherein the shape-maintaining layer contains a fiber-reinforced plastic.

17. The solid-state battery package according to claim 1, wherein the shape-maintaining layer contains a metal.

18. The solid-state battery package according to claim 1, wherein the shape-maintaining layer is a glass epoxy substrate.

19. The solid-state battery package according to claim 1, wherein the shape-maintaining layer has a thickness of 20 μm to 500 μm.

20. The solid-state battery package according to claim 1, wherein the shape-maintaining layer is constructed as a warpage-prevention layer that prevents warpage of the solid-state battery package.
